(19) United States
(12) Patent Application Publication
(10) Pub. No.: US 2011/0134097 A1
(43) Pub. Date: Jun. 9, 2011

(54) DISPLAY DEVICE AND COMPUTER READABLE STORAGE MEDIUM RECORDING PROGRAM

(75) Inventor: Hiroki SUGAMATA, Nagoya-shi (JP)

(73) Assignee: BROTHER KOGYO KABUSHIKI KAISHA, Nagoya-shi (JP)

(21) Appl. No.: 13/021,043

(22) Filed: Feb. 4, 2011

Related U.S. Application Data
(63) Continuation-in-part of application No. PCT/JP2009/055591, filed on Mar. 23, 2009.

(30) Foreign Application Priority Data
Aug. 7, 2008 (JP) 2008-204439

(51) Int. Cl. G09G 5/00

(52) U.S. Cl. 345/211

(57) ABSTRACT

A display device and a computer readable storage medium recording a program which can increase variations in information displayed in a power-source OFF state are provided. The display device includes: a non-volatile display part which is configured to maintain a display even when the supply of electricity from a power source is cut off; and an information storage part which is configured to store content information which contains information to be displayed on the non-volatile display part and additional information to be added to the content information. The display device is configured to display the additional information on the non-volatile display part when the display device is shifted from a power-source ON state to a power-source OFF state.

### CROSS-REFERENCE TO RELATED APPLICATIONS

The present application is a Continuation-in-Part of International Application PCT/JP2009/055591 filed on Mar. 23, 2009, which claims the benefits of Japanese Patent Application No. 2008-204439 filed Aug. 7, 2008.

### BACKGROUND

1. Field

The present invention relates to a display device and a computer readable storage medium recording a program, and more particularly to a display device and a computer readable storage medium recording a program which can maintain a display even when the supply of electricity from a power source is cut off.

2. Description of the Related Art

Conventionally, there has been used a display device such as an electronic paper having a non-volatile display part which maintains a display state even when the supply of electricity from a power source is cut off. In such a display device, by maintaining information displayed on the non-volatile display part as it is immediately before the display device is brought into a power-source OFF state from a power-source ON state, even after the display device is shifted from the power-source ON state to the power-source OFF state, the display device can perform a display such that a user can browse the information which had been displayed before shifting. For example, to consider a case where the display device is shifted from a power-source ON state to a power-source OFF state in a state where certain content information is displayed, the display device can continue the display while maintaining the displayed content information as it is.

On the other hand, from the viewpoint of strengthening security or the like, there has been also commercially available a display device which performs a blank display in which information which is displayed on a non-volatile display part immediately before the display device is brought into a power-source OFF state from a power-source ON state is erased, and character information such as “the power source is turned off” is displayed on the display part.

### SUMMARY

However, in the above-mentioned display device, when the display device is shifted from a power-source ON state to a power-source OFF state, the display device merely performs the display of content information which is displayed immediately before the display device is shifted to the power-source OFF state or performs the above-mentioned blank display. That is, the display device does not perform the display of information other than the content information and the blank display. Further, the content information and the blank display may be information which a user sometimes does not intend to browse. Accordingly, there are few variations in information to be displayed in a power-source OFF state.

Accordingly, it is an object of the present invention to provide a display device and a computer readable storage medium recording a program which can increase variations in information displayed in a power-source OFF state.

To achieve the above-mentioned object, according to one aspect of the present invention, there is provided a display device which includes: a non-volatile display part which is configured to maintain a display even when the supply of electricity from a power source is cut off; a control part which is configured to drive the non-volatile display part thus allowing the non-volatile display part to display information thereon; and an information storage part which is configured to store content information which contains information to be displayed on the non-volatile display part and additional information to be added to the content information, wherein the control part is configured to display the additional information on the non-volatile display part when the display device is shifted from a power-source ON state to a power-source OFF state.

To achieve the above-mentioned object, according to another aspect of the present invention, there is provided a computer readable storage medium recording a program to be executed by a computer in a display device, the program causing the computer to perform the steps of: maintaining a display on a non-volatile display part even when the supply of electricity from a power source is cut off; displaying information on the non-volatile display part; storing content information which contains information to be displayed on the non-volatile display part and additional information to be added to the content information; and displaying the additional information on the non-volatile display part when the display device is shifted from a power-source ON state to a power-source OFF state.

### BRIEF DESCRIPTION OF THE DRAWINGS

FIG. 1 is a front view of a display device;

FIG. 2 is a schematic view showing the electric constitution of the display device and an external terminal;

FIG. 3 is a front view of an electrophoretic display device;

FIG. 4 is a cross-sectional view of the electrophoretic display device taken along a line I-I in FIG. 3 as viewed in the direction indicated by an arrow;

FIG. 5 is a cross-sectional view of the electrophoretic display device taken along a line II-II in FIG. 3 as viewed in the direction indicated by an arrow;

FIG. 6A is an explanatory view showing an additional information table for power-source OFF time of the display device;

FIG. 6B is an explanatory view showing an additional information table for power-source OFF time of the display device;

FIG. 7A is an explanatory view showing a state where content are displayed on the electrophoretic display device;

FIG. 7B is an explanatory view showing a state where content are displayed on the electrophoretic display device;

FIG. 7C is an explanatory view showing a state where content are displayed on the electrophoretic display device;

FIG. 7D is an explanatory view showing a state where content are displayed on the electrophoretic display device;

FIG. 7E is an explanatory view showing a state where content are displayed on the electrophoretic display device;

FIG. 8 is a flowchart showing the manner of operation of processing which is executed in the display device;

FIG. 9 is a flowchart showing the manner of operation of processing which is executed in the display device;

FIG. 10 is a flowchart showing the manner of operation of processing which is executed in the display device;

FIG. 11 is a flowchart showing the manner of operation of processing which is executed in the external terminal;

FIG. 12A is a flowchart showing the manner of operation of processing which is executed in the display device;

FIG. 12B is a flowchart showing the manner of operation of processing which is executed in the display device;

FIG. 13 is a flowchart showing the manner of operation of processing which is executed in the display device; and

FIG. 14 is a flowchart showing the manner of operation of processing which is executed in the display device and a server.

### DESCRIPTION OF THE PREFERRED EMBODIMENTS

Hereinafter, one embodiment of the present invention is explained in conjunction with drawings.

The present invention relates to a control of a display device when the display device is shifted from a power-source ON state to a power-source OFF state, and the control is applied to a display device 1 of the embodiment explained hereinafter.

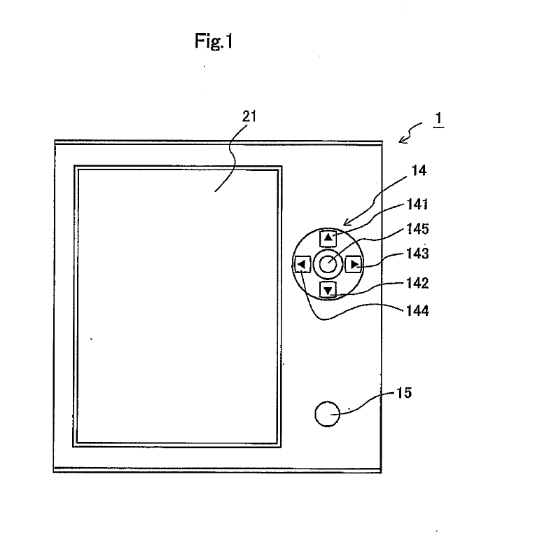

Firstly, an external appearance and the main manner of operation of the display device 1 are explained in conjunction with FIG. 1.

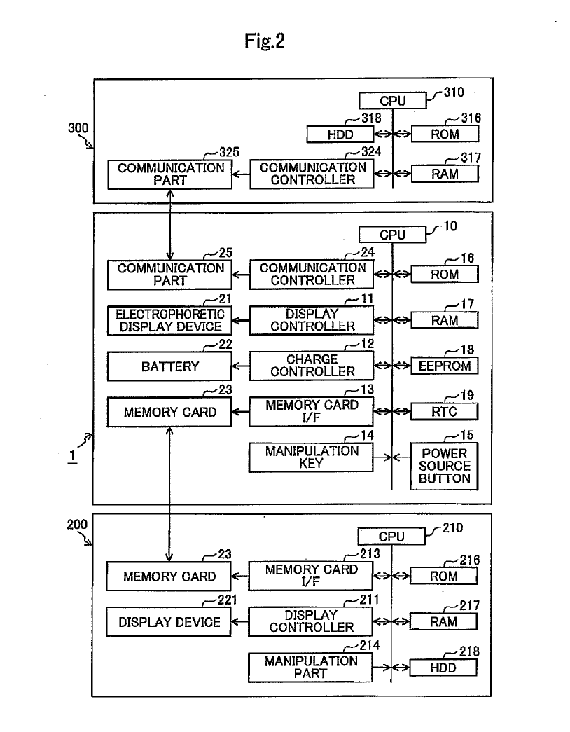

As shown in FIG. 1, the display device 1 has an approximately rectangular parallelepiped shape, and an electrophoretic display device 21 is mounted on a front surface of the display device 1. Although not shown in FIG. 1, on a right side surface of the display device 1, a card slot into which a memory card 23 (see FIG. 2) is inserted is formed. In the display device 1, the electrophoretic display device 21 can display content stored in the memory card 23. In this embodiment, at least one of characters, still images and moving images can be displayed as “content”. Further, “content” is constituted of at least one data out of data for displaying characters, data for displaying images, and data for displaying moving images. These data are referred to as “content body”. Further, with respect to “content” of this embodiment, “additional information” which is added to the content is attached to the content body. The additional information contains, for example, at least information to be displayed on the electrophoretic display device 21 in a power source OFF state. Further, the additional information may not be displayed in a power-source ON state, but may be displayed in a power-source OFF state.

Further, on a right side of the electrophoretic display device 21, a manipulation key 14 which constitutes a manipulation part manipulated by a user is mounted. On upper, lower, left and right sides of a decision key 145 which is arranged at the center of the manipulation key 14, an upper key 141, a lower key 142, a left key 144 and a right key 143 are respectively arranged. For example, the upper key 141 and the lower key 142 are keys for selecting content on a table-of-content screen or a menu screen, and the left key 144 and the right key 143 are keys for turning a page on which content is displayed. By manipulating these manipulation keys 14 corresponding to the information displayed on the electrophoretic display device 21, the content stored in the memory card 23 can be displayed or instructions for various settings can be made.

A power source button 15 is arranged below the manipulation key 14. The power source button 15 is a key for instructing a turning ON/OFF operation of the display device 1.

Next, the electrical constitution of the display device 1 is explained in conjunction with FIG. 2.

As shown in FIG. 2, the display device 1 includes a CPU 10 which constitutes a control part, a display controller 1I, a charge controller 12, a memory card interface (I/F) 13, the manipulation key 14, the power source button 15, a ROM 16, a RAM 17, an EEPROM 18, an RTC 19, and a communication controller 24.

The CPU 10 controls the display device 1. The CPU 10 particularly displays information by driving the electrophoretic display device 21 (non-volatile display part). The ROM 16 stores various kinds of information and a display terminal program for operating the display device 1. The program may not be preliminarily stored in the ROM 16, and may be taken out from a storage medium such as the memory card 23 via the memory card I/F 13 and may be stored in the ROM 16. In this case, the program is stored in the memory card 23, and a flash memory or the like is used as the ROM 16. The RAM 17 is a memory for temporarily storing various kinds of data, and the EEPROM 18 is a nonvolatile memory which stores an identification number of the display device 1 or the like. The RTC (Real Time Clock) 19 measures time. The display controller 11 controls a display of information on the electrophoretic display device 21 (see FIG. 1). The memory card I/F 13 controls reading and writing of information from and to the memory card 23. Further, the communication controller 24 controls a communication part 25 so as to enable the communication between the display device 1 and other devices such as a server 300. When electricity is not supplied to the display device 1 from an external power source not shown in the drawing, the display device 1 is driven with electricity supplied from a battery 22. An electricity supply path from the battery 22 or the external power source is constituted of two systems consisting of a system for supplying electricity to the CPU 10 and the other system for supplying electricity to peripheral equipments such as the ROM 16, the RAM 17, the EEPROM 18 and the display controller 11. Further, the charge controller 12 controls the charging of the battery 22 from the external power source.

Further, in the display device 1, a user can instruct the turning ON/OFF operation of the power source by pressing the power source button 15. When the power source button 15 is pressed or the manipulation key 14 is pressed in a state where the power source is in an OFF state, it is determined that an instruction “power source ON” is given so that electricity is supplied to the CPU 10 and the peripheral equipments whereby the display device 1 is brought into an operation state. On the other hand, when the power source button 15 is pressed in a state where the power source is in an ON state, it is determined that an instruction “power source OFF” is given so that processing for turning off the power source is executed whereby the supply of electricity to the CPU 10 and the peripheral equipments is cut off. Also when the manipulation by the user is not performed for a predetermined time (power-source OFF set time), it is determined that the display device 1 is in a non-use state so that the processing for turning off the power source is executed whereby the supply of electricity to the CPU 10 and the peripheral equipments is cut off.

Here, the power source OFF state in this embodiment is a state where electricity cannot be supplied to the display device 1 from the battery 22 because of the shortage of charge, unloading of the battery 22 per se or the like, or a state where even when electricity can be supplied to the display device 1 from the battery 22, electricity cannot be supplied to at least any one of the electrophoretic display device 21, the CPU 10 and the peripheral equipments (the RAM 17, the respective controllers such as the display controller 11 and the like) due to a specific manipulation such as a pressing operation of the power source button 15 by a user or a non-manipulation by a user for a predetermined time. To be more specific, the power source OFF state implies any one of or a plurality of states selected from the following states (a) to (e). (a) A state where the power source is explicitly turned off due to a specific manipulation by a user such as a pressing operation of the power source button (including a manipulation to turn off the power source based on power source OFF setting when a preset time elapses), (h) a state where the supply of electricity to the display part is stopped, (c) a state where the supply of electricity to the peripheral equipments (the RAM, the respective controllers and the like) is stopped, (d) a state where the supply of electricity to the CPU is stopped, and (e) a state where the supply of electricity is stopped and the whole system is stopped (also a state where the supply of electricity is completely stopped due to the removal of the battery).

The electrophoretic display device 21 is a nonvolatile display part which possesses non-volatility, and can maintain a display state even when the supply of electricity to the electrophoretic display device 21 is cut off. That is, the electrophoretic display device 21 can maintain the display even when the supply of electricity from the power source is cut off. Accordingly, a user can visually recognize the maintained (held) information even when the electrophoretic display device 21 is in a power source OFF state thus realizing power saving.

Further, the display device 1 can perform the reading and writing of data via the external terminal 200 and the memory card 23. The external terminal 200 supplies content body such as documents, information relating to the content and the like to the display device 1.

The external terminal 200 includes a CPU 210 which constitutes a control part, a display controller 211, a memory card interface (I/F) 213, a manipulation part 214, a ROM 216, a RAM 217, and a hard disk drive (HDD) 218.

The CPU 210 controls the external terminal 200. The ROM 216 stores various kinds of information and a display terminal program for operating the external terminal 200. The RAM 217 is a memory for temporarily storing various kinds of data, and the HDD 218 is a nonvolatile storage medium for storing various kinds of information on the external terminal 200. Further, the display controller 211 controls the display of information on the display device 221. The memory card I/F 213 controls the reading and writing of information from and to the memory card 23.

The external terminal 200 is used for supplying content to the display device 1 via the memory card 23. The external terminal 200 is particularly used for supplying additional information corresponding to the content.

Further, the display device 1 is communicable with the server 300 via a communication network (not shown in the drawing). The server 300 supplies content body such as documents, information relating to the content and the like to the display device 1.

The server 300 includes a CPU 310 which constitutes a control part, a ROM 316, a RAM 317, a hard disk drive (HDD) 318 and a communication controller 324.

The CPU 310 controls the server 300. The ROM 316 stores various kinds of information and a program for operating the server 300. The RAM 317 is a memory for temporarily storing various kinds of data, and the HDD 318 is a nonvolatile storage medium for storing various kinds of information on the server 300. Further, the communication controller 324 controls the communication part 325 and is communicable with other devices such as the display device 1.

Although the server 300 is used for supplying content to the display device 1 via a communication network (not shown in the drawing), the server 300 is particularly used for supplying additional information corresponding to the content to the display device 1.

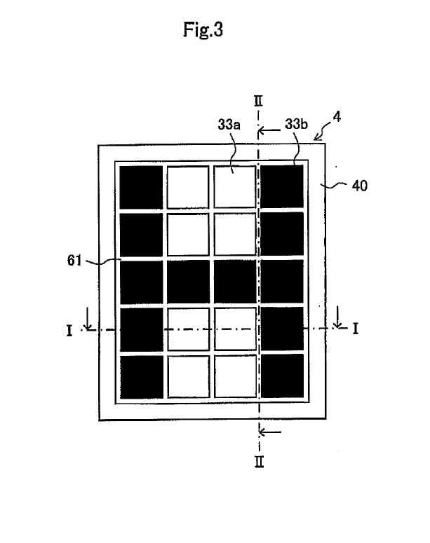

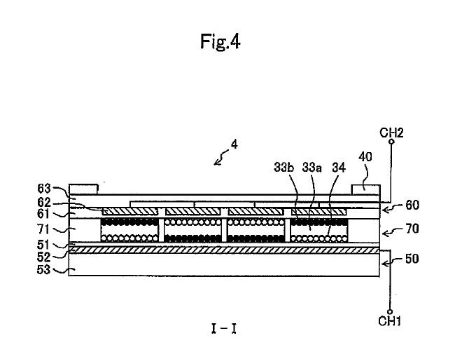

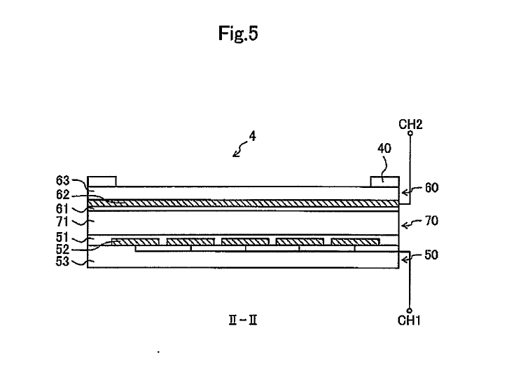

Here, the physical constitution of the electrophoretic display device 21 is schematically explained in conjunction with FIG. 3 to FIG. 5.

As shown in FIG. 3 to FIG. 5, the electrophoretic display device 21 is configured such that a lower substrate 50 which constitutes a lower surface portion of the electrophoretic display device 21 and an upper substrate 60 which constitutes an upper surface portion of the electrophoretic display device 21 are arranged to face each other in an opposed manner, and a display part 70 is arranged between the lower substrate 50 and the upper substrate 60. In FIG. 3 to FIG. 5, for facilitating the explanation of the electrophoretic display device 21, the number of pixels is set to 20 (5×4). However, in the actual structure, the required number of pixels can be provided.

The lower substrate 50 includes a lower electrode 52 which generates an electric field in the display part 70, a lower electrode protective film 51 which is an insulation film formed by applying an insulation material to an upper surface side of the lower electrode 52 by coating, and a casing support portion 53 which is arranged on a lower surface side of the lower electrode 52 and supports the display device 1. The lower electrode protective film 51 is formed of a material exhibiting a high insulation property such as a resin film made of polyethylene terephthalate or an inorganic material represented by silica or glass. In this embodiment, the lower electrode protective film 51 and the casing support portion 53 are respectively formed of a plastic substrate (resin film) made of polyethylene terephthalate having resiliency. The lower electrode 52 is a substrate which includes a plurality of electrodes formed by arranging a plurality of linear electrical conductive bodies parallel to each other in the lateral direction (the direction along the I-I line in FIG. 3) such that a fixed voltage is applied to the lower electrode 52.

Above the lower substrate 50, the upper substrate 60 is arranged to face the lower substrate 50 in an opposed manner and parallel to the lower substrate 50 with a predetermined distance therebetween. The upper substrate 60 includes an upper electrode 62 which generates an electric field in a display part 70, an upper electrode protective film 61 which is an insulation film formed by applying an insulation material to a lower surface side of the upper electrode 62, and a display layer 63 which is arranged on an upper surface side of the upper electrode 62 and is formed of a transparent member thus functioning as a display screen. The upper electrode protective film 61 is formed of a material exhibiting high transparency such as polyimide, polyethylene terephthalate or glass. The upper electrode 62 is a substrate which includes a plurality of electrodes formed by arranging a plurality of linear electrical conductive bodies parallel to each other in the longitudinal direction (the direction along the II-II line in FIG. 3) such that a fixed voltage is applied to the upper electrode 62. The upper electrode 62 is formed of a material exhibiting high transparency. In this embodiment, the upper electrode protective film 61 is formed of a plastic substrate (resin film) made of polyethylene terephthalate. The upper electrode 62 is a transparent electrode made of indium tin oxide (ITO), and the display layer 63 is formed of a glass substrate. That is, since the upper substrate 60 is a transparent body, the electrophoretic display device 21 functions as a display substrate through which a user can visually recognize the display part 70 from above the upper substrate 60.

Next, the display part 70 is explained. A gap defined by the lower substrate 50 and the upper substrate 60 which are arranged to face each other in an opposed manner and a spacer 71 constitutes the display part 70. The spacer 71 is arranged to extend in the gap defined between the lower substrate 50 and the upper substrate 60. The spacer 71 uniformly divides the gap in a matrix array thus forming a plurality of small partitioned cells and also supports the lower substrate 50 and the upper substrate 60. The spacer 71 is a resilient member which is formed as a plate-like member in which a plurality of through holes are formed in a matrix array. The spacer 71 may be made of a synthetic resin such as polyimide or polyethylene terephthalate, for example.

The inside of the display part 70 is filled with electrically charged particles 33a, 33b and a dispersion medium 34. The electrically charged particles 33a, 33b are made of a material which is chargeable in the dispersion medium 34. That is, the electrically charged particles 33a, 33b are formed of pigment or dye made of an organic compound or an inorganic compound, or a material formed by covering pigment or dye with a synthetic resin. The electrically charged particles 33a used in this embodiment are formed of a mixture of a styrene resin and titanium dioxide, have an average particle size of 5 μm (7 wt %), and contain 40 wt % of titanium dioxide in each particle. The electrically charged particles 33b used here are formed of a mixture of a styrene resin and carbon black, have an average particle size of 5 μm (10 wt %), and contain 30 wt % of carbon black in each particle. Accordingly, the electrically charged particles 33a exhibit a white tone, and the electrically charged particles 33b exhibit a black tone. The electrically charged particles 33a and the electrically charged particles 33b are electrically charged into different poles, that is, a positive pole and a negative pole respectively. In this embodiment, the electrically charged particles 33a are electrically charged into a negative pole, and the electrically charged particles 33b are electrically charged into a positive pole.

As the dispersion medium 34, alcoholics, hydrocarbon, silicone oil or the like which exhibits high insulation property and low viscosity can be used. In this embodiment, Isopar (73 wt %) made by Exxon Mobile Corporation, which is a paraffinic solvent, is used. Ethanol (10 wt %) is added to the dispersion medium 34 as an additive agent.

Further, on an upper surface of the upper substrate 60 (a surface of the upper substrate 60 which does not face the lower substrate 50), a mask portion 40 is provided for concealing a peripheral portion of the display part 70 where small partitioned cells are not present so that a user cannot visually recognize the peripheral portion when the viewer observes the display device 1 from a front side. The mask portion 40 is a hollow rectangular plate member which is formed on and along four sides of the upper substrate 60 with a fixed width and has a through hole such that a user can visually recognize the display part 70 through the through hole. The mask portion 40 may be formed by adhering a colored synthetic resin such as polyethylene terephthalate or may be formed by an ink layer printed on a surface of the display layer 63. When the user views the electrophoretic display device 21 from above, the user can visually recognize the display part 70 through the through hole formed in the mask portion 40.

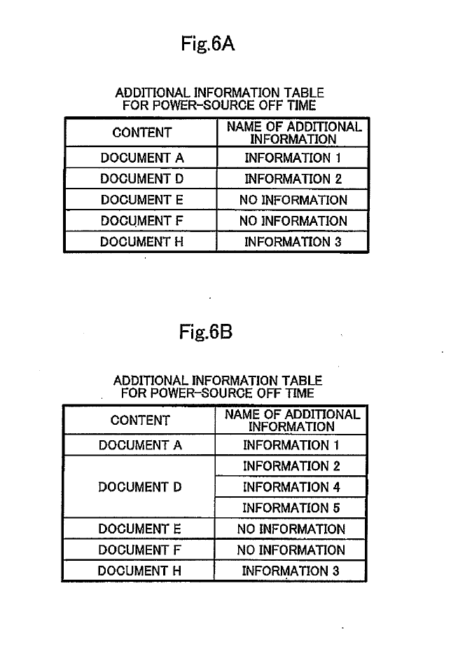

Next, in conjunction with FIG. 6A, the explanation is made with respect to an additional information table for power-source OFF time for determining information to be displayed on the electrophoretic display device 21 in a power-source OFF state when the display device 1 is shifted from a power-source ON state to the power-source OFF state.

The additional information table for power-source OFF time is a table which mainly shows additional information to be displayed on the electrophoretic display device 21 in a power-source OFF state. The additional information table for power-source OFF time is stored in the EEPROM 18 or the memory card 23 of the display device 1, and can be set in response to the manipulation of the manipulation key 14 or the manipulation portion 214 of the external terminal 200. The additional information table for power-source OFF time is, as shown in FIG. 6A, set such that the content and the additional information are made to correspond to each other.

In this manner, the content (content information) and the additional information are stored in the additional information table for power-source OFF time in a corresponding manner as shown in FIG. 6A. The additional information table for power-source OFF time is stored in the EEPROM 18, the memory card 23 or the like. Accordingly, the EEPROM 18 or the memory card 23 stores content information which contains information to be displayed on the electrophoretic display device 21 and additional information which is to be added to the content information. That is, the EEPROM 18 and the memory card 23 are one example of the information storage part.

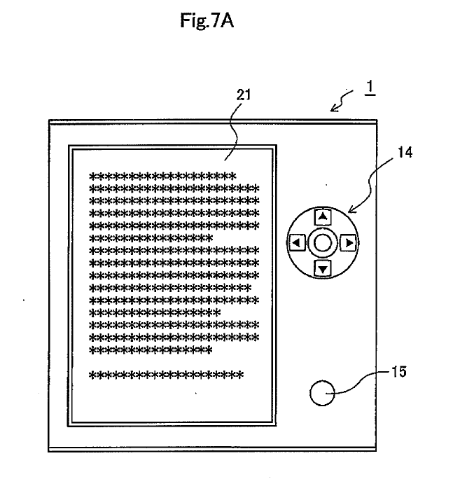

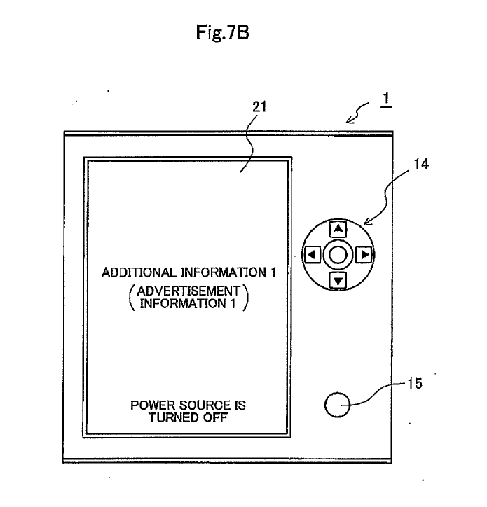

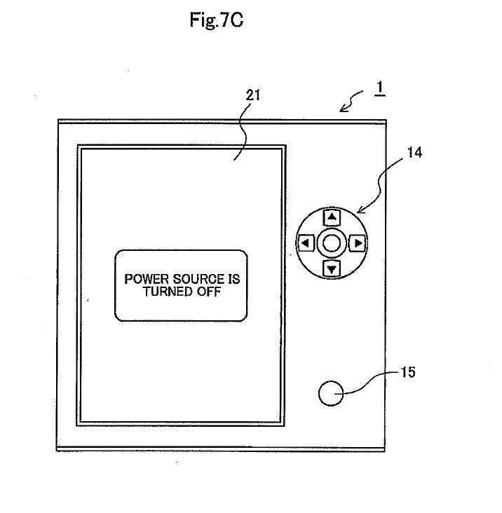

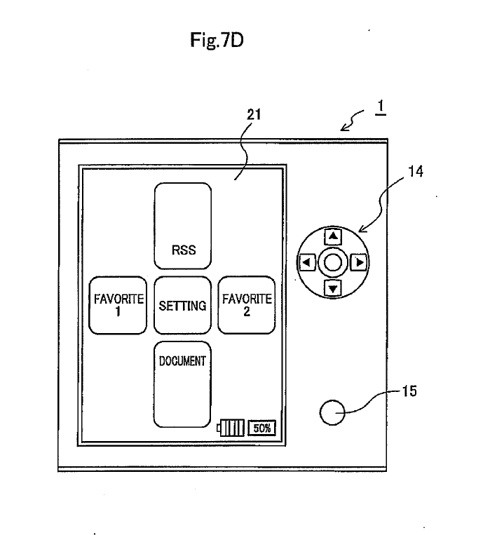

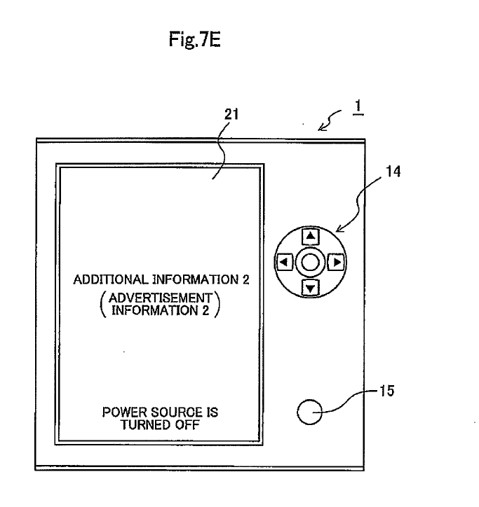

Next, the display content of the electrophoretic display device 21 is explained in conjunction with FIG. 7A to FIG. 7E.

On the electrophoretic display device 21, in a power-source ON state, various kinds of information such as content of a mail shown in FIG. 7A is displayed. In this case, information on page or the like is displayed on a lower side of the display region of the electrophoretic display device 21.

Further, in such a power-source ON state, when the power source button 15 is pressed or when a power-source OFF set time elapses without performing the manipulation of the manipulation key 14, the display device 1 is shifted from the power-source ON state to a power-source OFF state. In this case, as shown in FIG. 7B, predetermined additional information 1 (for example, advertisement information 1) is displayed, and a message “Power source is turned off” is displayed on a lower side of the display region of the electrophoretic display device 21. Further, the additional information 1 may be information which corresponds to content information displayed on the electrophoretic display device 21 immediately before the display device 1 is brought into the power-source OFF state.

Here, in this embodiment, when the additional information is made to correspond to the content information which is displayed on the electrophoretic display device 21 immediately before the display device 1 is shifted to the power-source OFF state, the additional information is displayed in the power-source OFF state. However, when the additional information is not made to correspond to the content information, as shown in FIG. 7C, a blank display is performed. In the blank display, display content over the whole display region of the electrophoretic display device 21 is erased, and a message “Power source is turned OFF” is displayed at the center of the display region of the electrophoretic display device 21.

Further, in a power-source OFF state shown in FIG. 7B or FIG. 7C, when the power source button 15 is pressed or when another manipulation key 14 is manipulated after the power-source OFF set time elapses, the display device 1 is shifted from a power-source OFF state to a power-source ON state and, as shown in FIG. 7D, a top page is displayed on the display region of the electrophoretic display device 21.

Here, the explanation is made specifically with respect to a case where a weekly comic magazine or the like is adopted as content information and advertisement information on a comic book is adopted as additional information added to the content information. In this case, when a weekly comic magazine which a user wants to read is downloaded from the server 300 via a communication network, the weekly comic magazine is automatically downloaded in a form that the advertisement information on the comic book is added to the weekly comic magazine. Further, when the content of the weekly comic magazine is displayed on the electrophoretic display device 21 immediately before the display device 1 is shifted to a power-source OFF state, advertisement information on the comic book which is correlated with the weekly comic magazine is displayed on the electrophoretic display device 21 in the power-source OFF state.

In this manner, when additional information is advertisement information, there arises opportunity that the advertisement information is displayed together with the content information. Accordingly, for example, in the case where the advertisement information is added to the content information when a user purchases the content information, a cost the user pays for purchasing the content information can be reduced. Further, by adding advertisement information correlated with the content information to the content information, the display device 1 can display the advertisement information correlated with the content information.

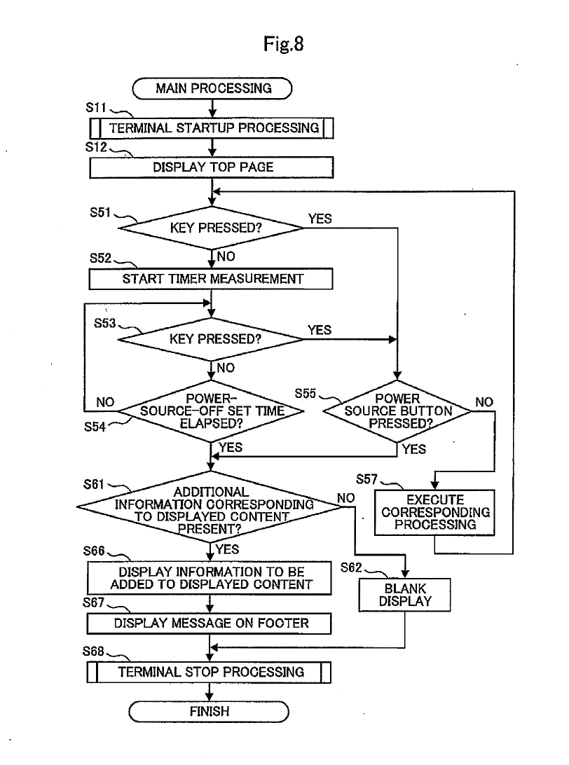

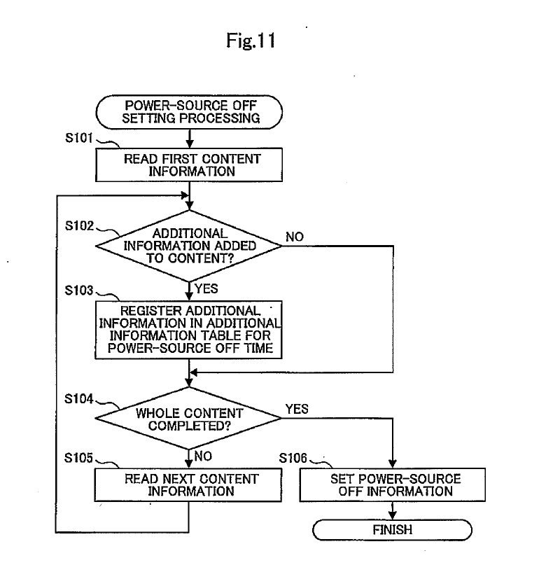

Next, the manner of operation of the display device 1 and the like is explained in conjunction with flowcharts shown in FIG. 8 to FIG. 11. FIG. 8 to FIG. 10 are flowcharts showing the manner of operation of processing executed by the display device 1, and FIG. 11 is a flowchart showing the manner of operation of processing executed by the external terminal 200. Particularly, main processing showing in FIG. 8 is started when the power source of the display device 1 is turned on. That is, the main processing is started when the power source button 15 is pressed or when the manipulation key 14 is pressed.

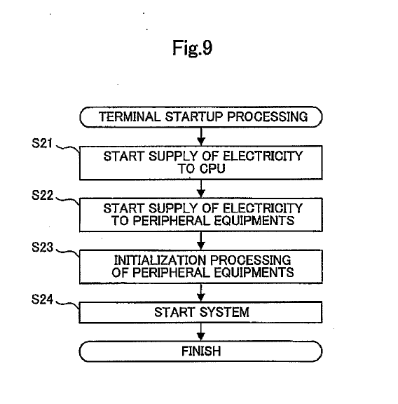

Firstly, as shown in FIG. 8, in the main processing, the CPU 10 performs terminal startup processing (step S11). Although described in detail later in conjunction with FIG. 9, the CPU 10 executes startup processing of the display device 1. Then, the CPU 10 displays a top page on the electrophoretic display device 21 (step S12). That is, the CPU 10 performs a control such that the top page is displayed as shown in FIG. 7D.

Next, the CPU 10 determines whether or not an arbitrary key such as the manipulation key 14 is pressed (step S51). When the CPU 10 determines that the arbitrary key is pressed (step S51: YES), processing advances to step S55. When the CPU 10 determines that the arbitrary key is not pressed (step S51: NO), the timer measurement is started for measuring a power-source-OFF set time (step S52), and processing advances to step S53.

Also in step S53, the CPU 10 determines whether or not the arbitrary key such as the manipulation key 14 is pressed. When the CPU 10 determines that the arbitrary key is pressed (step S53: YES), processing advances to step S55. When the CPU 10 determines that the arbitrary key is not pressed (step S53: NO), the CPU 10 determines whether or not a power-source-OFF set time elapses (step S54). When the CPU 10 determines that a power-source-OFF set time elapses (step S54: YES), processing advances to step S61. When the CPU 10 determines that a power-source-OFF set time does not elapse (step S54: NO), processing returns to step S53 again.

As described above, the display device 1 is shifted from a power-source ON state to a power-source OFF state when there is no manipulation of the manipulation key 14 within the predetermined time and hence, the number of opportunities where the display device 1 is shifted to the power-source OFF state from the power-source ON state is increased whereby the number of opportunities that the additional information is displayed can be increased. Further, by shortening a time during which the display device 1 is in a power-source ON state, it is possible to further enhance power saving. In this embodiment, although the power-source-OFF set time is set in a body of the display device 1 in a changeable manner, the present invention is not limited to such constitution.

In step S55, the CPU 10 determines whether or not the power source button 15 is pressed. When the CPU 10 determines that the power source button 15 is pressed (step S55: YES), processing advances to step S61, while when the CPU 10 determines that the power source button 15 is not pressed (step S55: NO), processing corresponding to such manipulation is executed (step S57), and processing returns to step S51 again.

Due to such processing, in a power-source ON state, when the arbitrary key is not manipulated and a power-source-OFF set time elapses or when the power source button 15 is manipulated, processing advances to step S61.

In step S61, the CPU 10 determines whether or not additional information which corresponds to displayed content information is present. When the CPU 10 determines that the additional information which corresponds to the displayed content information is present (step S61: YES), processing advances to step S66 as shown in FIG. 7B. Here, the CPU 10 displays the additional information which corresponds to the displayed content information on the electrophoretic display device 21 (step S66), displays a message “The power source is turned off” on a footer (a lower side of the display region) (step S67), and processing advances to step S68.

In this manner, when the display device 1 is shifted from a power-source ON state to a power-source OFF state, the CPU 10 displays the additional information which is added to the content information displayed in the power-source ON state immediately before the shifting on the electrophoretic display device 21. Accordingly, the electrophoretic display device 21 can display the additional information which is added to the content information besides the content information when the display device 1 is shifted to the power-source OFF state and hence, variations in information displayed in the power-source OFF state can be increased. Further, by allowing the electrophoretic display device 21 to display the additional information instead of the content information, a user can recognize that the display device 1 is in a power-source OFF state. Further, by allowing the electrophoretic display device 21 to display the additional information added to the content information which the user views when the display device 1 is shifted from the power-source ON state to the power-source OFF state, the power-source ON state and the power-source OFF state can be correlated with each other.

On the other hand, when the CPU 10 determines that the additional information corresponding to the content information does not exist (step S61: NO), a blank display is performed as shown in FIG. 7C (step S62), and processing advances to step S68. In the blank display, the CPU 10 erases information displayed on the electrophoretic display device 21 and allows the electrophoretic display device 21 to display a message “The power source is turned off”.

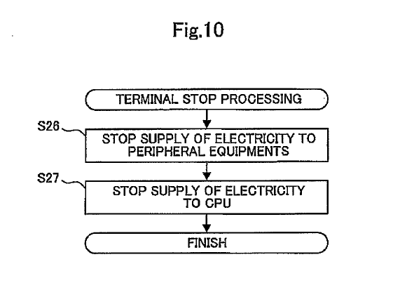

Then, the CPU 10 performs terminal stop processing (step S68). Although the terminal stop processing is explained in detail later in conjunction with FIG. 10, the CPU 10 executes processing of stopping the display device 1 so that the display device 1 is brought into a power saving mode.

In terminal startup processing which is called in step S11 in FIG. 8 or the like, firstly, as shown in FIG. 9, the supply of electricity to the CPU 10 is started (step S21) and, subsequently, the supply of electricity to the peripheral equipments is started (step S22). Then, initialization processing of the peripheral equipments is executed (step S23) so that the system is started in the CPU 10 (step S24). When such system starting is executed, the following processing is executed.

In terminal stop processing called in step S68 or the like shown in FIG. 8, firstly, as shown in FIG. 10, the CPU 10 stops the supply of electricity to the peripheral equipments (step S26) and, then, the supply of electricity to the CPU 10 is stopped (step S27). Due to such processing, the display device 1 is brought into a power saving mode.

Next, as shown in FIG. 11, in power-source OFF setting processing called in the external terminal 200 at a predetermined cycle, a CPU 210 in the external terminal reads the first content information (step S101).

Then, the CPU 210 determines whether or not additional information is added to the content information (step S102). In this processing, the CPU 210 determines whether or not the additional information is added to content information based on whether or not setting for adding additional information to content information is executed in response to the manipulation of the manipulation part 214. When the CPU 210 determines that additional information is added to content information (step S102: YES), the additional information is registered in the additional information table for power-source OFF time in the memory card 23 (step S103), and processing advances to step S104. Due to such processing, the additional information can be added to the content information in the external terminal 200. On the other hand, when the CPU 210 determines that the additional information is not added to the content information (step S102: NO), processing advances to step S104 without executing step S103.

In step S104, the CPU 210 determines whether or not the whole content is completed in response to the manipulation of the manipulation part 214. When the CPU 210 determines that the whole content is not completed, the CPU 210 reads next content information (step S105), and processing returns to step S102 again. Due to such processing, it is possible to set whether or not additional information is to be added for every content information. On the other hand, when the CPU 210 determines that the whole content is completed, power-source OFF information is set (step S106) so that this processing is finished. Due to such processing, the setting whether or not additional information is to be added to content information is finished. Then, the CPU 210 stores the content information and the information correlated with the additional information to be added to the content information in the memory card 23 in a corresponding manner. The CPU 10 of the display device 1 which reads information in the memory card 23 can display the content information and the information correlated with the additional information on the electrophoretic display device 21.

As has been explained heretofore, the display device 1 of this embodiment stores content information which contains information to be displayed on the electrophoretic display device 21 and additional information which is added to the content information, and displays the additional information on the electrophoretic display device 21 when the display device 1 is shifted from a power-source ON state to a power-source OFF state. Accordingly, in addition to content information, additional information added to the content information can be displayed when the display device 1 is shifted to the power-source OFF state so that variations in information which are displayed in the power-source OFF state are increased. Further, by allowing the electrophoretic display device 21 to display the additional information instead of content information, the user can recognize that the display device 1 is in a power-source OFF state.

In the above-mentioned embodiment, the CPU 10 corresponds to “control part”, the electrophoretic display device 21 corresponds to “non-volatile display part”, the manipulation key 14 corresponds to “manipulation part”, and the EEPROM 18 and the memory card 23 correspond to “information storage part”.

It is needless to say that the display device 1 of the present invention is not limited to the display device of the above-mentioned embodiment and various modifications are conceivable without departing from the gist of the present invention.

In the above-mentioned embodiment, the additional information table for power-source OFF time shown in FIG. 6A is updated in the external terminal 200, and the CPU 10 acquires content information and additional information from the external terminal 200 via the memory card 23. However, the present invention is not limited to such an embodiment. For example, the display device 1 per se may update the additional information table for power-source OFF time. Further, content information and additional information may be acquired from the server 300 via a communication network, for example.

Further, in the above-mentioned embodiment, one additional information is added to one content information. However, the present invention is not limited to such a mode, and a plurality of additional information may be added to one content information, for example. Further, although the blank display is performed when additional information is not added to content information in the above-mentioned embodiment, the present invention is not limited to such an embodiment, and other information may be displayed at random.

Further, in the above-mentioned embodiment, once the display device 1 is shifted to a power-source OFF state, the display of additional information is not changed until the display device 1 assumes a power-source ON state. However, the present invention is not limited to the above-mentioned embodiment. For example, a plurality of additional information may be displayed in order. In this case, a time during which additional information is displayed may be set. Further, for example, a time which elapses until the display device 1 assumes a power-source OFF state from the last manipulation of the manipulation key 14 or the like may be set for every content information or for every additional information.

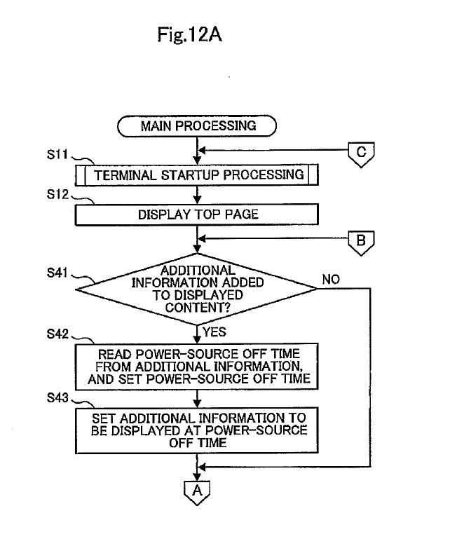

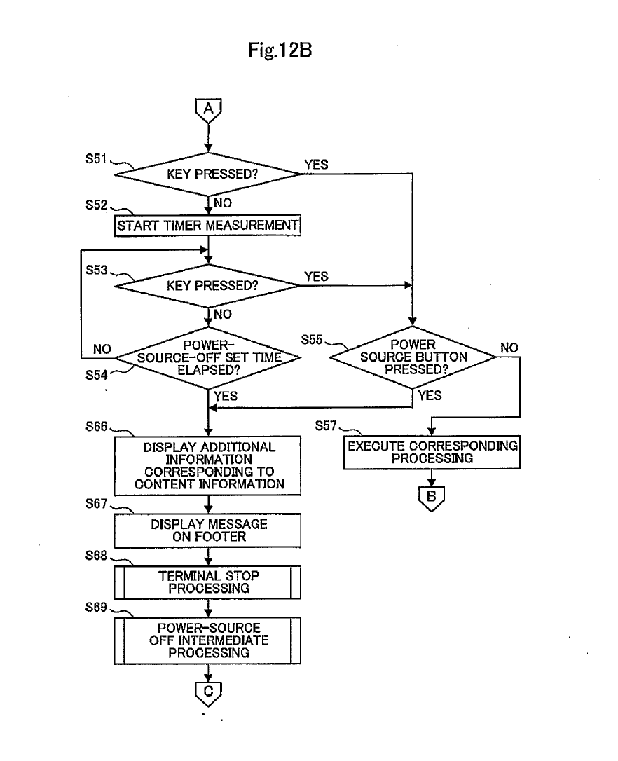

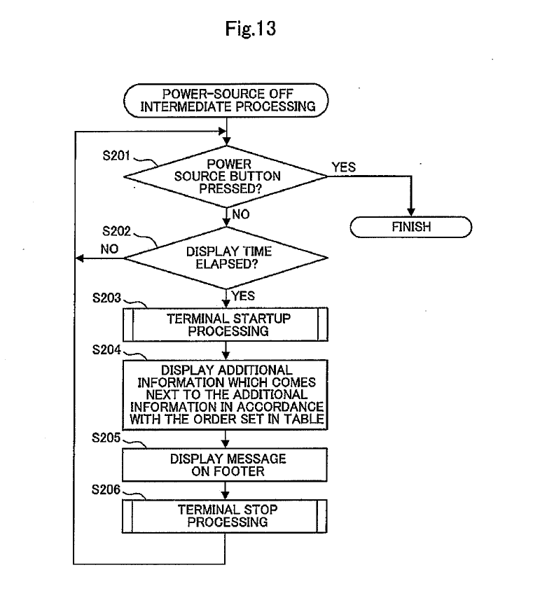

Such embodiments are explained in conjunction with FIG. 6B, FIG. 12A, FIG. 12B and FIG. 13 hereinafter. In these embodiments, for facilitating the understanding of the invention, the explanation is made mainly with respect to the constitution and the processing of this embodiment which differ from the constitution and the processing of the above-mentioned embodiment, and the explanation of the constitution and the processing of this embodiment substantially equal to the constitution and the processing of the above-mentioned embodiment is omitted.

Firstly, in an additional information table for power-source OFF time, as shown in FIG. 6B, a plurality of additional information can be added to content information in predetermined display order. To be more specific, the plurality of additional information are made to correspond to the content information referred to as “document D” in order of information 2, information 4 and information 5. Further, as the additional information, a power-source OFF set time and a display interval are made to correspond to the content information.

The “power-source OFF set time” is a time which brings the display device 1 into a power-source OFF state when the time elapses with no manipulation of the manipulation key 14. This power-source OFF set time can be set for every additional information besides the power-source OFF set time which is set in the main body of the display device 1. Here, priority is assigned to the power-source OFF set time set for every additional information over the power-source OFF set time set in the main body of the display device 1.

As one specific example, when the document D is displayed as content information, based on information 2 which is displayed when the display device 1 assumes a power-source OFF state, for example, a time 2 is set as the power-source OFF set time. Accordingly, when the time 2 elapses with no manipulation of the manipulation key 14 after the document D is displayed, the display device 1 is brought into a power-source OFF state.

When a plurality of additional information are set for one content information, the plurality of additional information are displayed in the predetermined order. “Display interval” indicates a time for displaying each of the plurality of additional information.

As one specific example, when the document D is displayed as content information, a display interval 2 is set as the display interval based on information 2, for example, a display interval 4 is set as the display interval based on information 4, for example, and a display interval 5 is set as the display interval based on information 5, for example. Due to such setting, when the document D is displayed as content information and the display device 1 is brought into a power-source OFF state, additional information is displayed only for the display interval 2 corresponding to the information 2. Then, when the display interval 2 elapses, another additional information is displayed only for the display interval 4 corresponding to the information 4. Then, when the display interval 4 elapses, another additional information is displayed only for the display interval 5 corresponding to the information 5. Then, when the display interval 5 elapses, again, the additional information is displayed only for the display interval 2 corresponding to the information 2.

Such an additional information table for power-source OFF time is set in step S103 in FIG. 11 described above, and is stored in the memory card 23 in step S106. Accordingly, in the display device 1, the CPU 10 can read the additional information from the memory card 23 and executes the following processing.

Next, the main processing is explained in conjunction with FIG. 12A. When processing in step S12 is finished, the CPU 10 advances processing to step S41. In step S41, the CPU 10 determines whether or not additional information is added to displayed content information.

When the CPU 10 determines that the additional information is added to the displayed content information (step S41: YES), processing advances to step S42. Then, the CPU 10 reads a power-source OFF time from the additional information, and sets the power-source OFF time in a predetermined region of the RAM 17 (step S42). As one specific example, when the document D shown in FIG. 6B is displayed, the CPU 10 looks up the additional information table for power-source OFF time shown in FIG. 6B, and sets the time 2 corresponding to the information 2 which is firstly displayed when the display device 1 is brought into a power-source OFF state.

Then, the CPU 10 reads additional information to be displayed at the power-source OFF time and sets the additional information in the predetermined region of the RAM 17 (step S43), and processing advances to step S51 shown in FIG. 12B. As one specific example, when the document D shown in FIG. 6B is displayed, the CPU 10 looks up the additional information table for power-source OFF time shown in FIG. 6B, and sets the information 2 which is firstly displayed when the display device 1 is brought into a power-source OFF state.

On the other hand, when the CPU 10 determines that additional information is not added to the displayed content information, processing advances to step S51 without executing step S42 and step S43.

As described above, before the display device 1 is brought into the power-source OFF state, the power-source OFF set time and the additional information which is displayed after the display device 1 is brought into the power-source OFF state are set. Then, the CPU 10 looks up the set power-source OFF set time in the above-described step S54. Then, when the display device 1 is brought into the power-source OFF state, the CPU 10 looks up the set additional information in step S66 as described above and the electrophoretic display device 21 displays the set additional information.

Further, when processing in step S68 is finished, the CPU 10 advances processing to step S69. Although step S69 is described in detail later in conjunction With FIG. 13, the CPU 10 executes power-source OFF intermediate processing. In this processing, when the electrophoretic display device 21 displays additional information at display intervals, the CPU 10 temporarily brings the display device 1 into a power-source ON state and changes over the additional information and, thereafter, brings the display device 1 into the power-source OFF state again. When such processing is finished, the CPU 10 returns processing to step S11.

In the power-source OFF intermediate processing called in step S69 in FIG. 12, firstly, as shown in FIG. 13, the CPU 10 determines whether or not the power source button 15 is pressed (step S201). When the CPU 10 determines that the power source button 15 is pressed (step S201: YES), various kinds of information such as the table shown in FIG. 6 are updated before the display device 1 is brought into the power-source OFF state, and this processing is finished. Then, the CPU 10 returns the processing to step S11 in FIG. 12. Due to such processing, when a user presses the power source button 15 in a power-source OFF state, the CPU 10 brings the display device 1 into a power-source ON state. On the other hand, when the CPU 10 determines that the power source button 15 is not pressed (step S210: NO), the CPU 10 advances processing to step S202.

In step S202, the CPU 10 determines whether or not a display time elapses. In this processing, the CPU 10 reads a display interval corresponding to additional information displayed on the electrophoretic display device 21, and determines whether or not the display time elapses. When the CPU 10 determines that the display time does not elapse (step S202: NO), the CPU 10 returns processing to step S201 again. On the other hand, when the CPU 10 determines that the display time elapses (step S202: YES), the CPU 10 advances processing to step S203.

Then, in step S203, the CPU 10 executes the terminal startup processing and starts an operation of the display device 1. Then, the CPU 10 allows the electrophoretic display device 21 to display additional information which comes next to the additional information which is displayed immediately before currently displayed additional information thereon in accordance with the order set in the additional information table for power-source OFF time shown in FIG. 6B (step S204). Then, the CPU 10 allows the electrophoretic display device 21 to display a message “The power source is turned off” on a footer (a lower side of the display region) (step S205). Then, the CPU 10 executes the terminal stop processing (step S206), and the CPU 10 returns processing to step S201 again.

Due to such processing, the CPU 10, in a power-source OFF state, temporarily brings the display device 1 into the power-source ON state from the power-source OFF state at timing that the display interval which corresponds to the displayed additional information elapses. Then, the CPU 10 changes over the additional information to be displayed on the electrophoretic display device 21. The CPU 10 brings the display device 1 into the power-source OFF state from the power-source ON state. Such processing is repeatedly executed at predetermined timings that the display times which are associated with the respective additional information elapse.

Accordingly, irrespective of whether the display device 1 is in a power-source OFF state or in a power-source ON state, it is possible to repeatedly change over the additional information at predetermined timings thus imparting variations to additional information to be displayed. Further, the CPU 10 temporarily brings the display device 1 into a power-source ON state and hence, a time during which the display device 1 is in a power-source ON state can be shortened thus realizing the further power saving.

Further, it may be also possible to temporarily bring the CPU 10 into a power-source ON state so as to change over additional information at timing that content information and the additional information are downloaded from the server 300 via a communication network. Further, the downloading of content information and the additional information is not limited to new downloading of content information and additional information, and may be downloading of content information and additional information for updating.

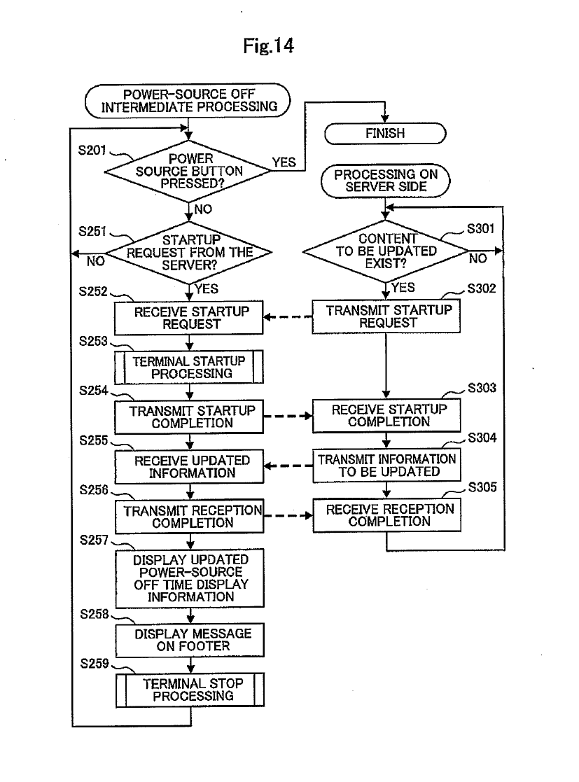

This embodiment is explained hereinafter in conjunction with FIG. 14. In this embodiment, for facilitating the understanding of the invention, the explanation is made mainly with respect to the constitution and the processing of this embodiment which differ from the constitution and the processing of the above-mentioned embodiment, and the explanation of the constitution and the processing of this embodiment substantially equal to the constitution and the processing of the above-mentioned embodiment is omitted.

In the display device 1, in power-source OFF intermediate processing called in step S69 in FIG. 12, firstly, as shown in FIG. 14, the CPU 10 determines whether or not the power source button 15 is pressed (step S201), When the CPU 10 determines that the power source button 15 is pressed (step S201: YES), the CPU 10 finishes this processing, and returns processing to step S11 in FIG. 12. Due to such processing, when a user presses the power source button 15 in a power-source OFF state, the CPU 10 brings the display device 1 into a power-source ON state. On the other hand, when the CPU 10 determines that the power source button 15 is not pressed (step S201: NO), the CPU 10 advances processing to step S251.

In step S251, the CPU 10 determines whether or not there is a startup request from the server.

On the other hand, in the server 300, the CPU 310 determines whether or not content information to be updated is present (step S301). This content information to be updated includes additional information to be updated although content information is not updated, for example.

When the CPU 310 determines that content information to be updated is present (step S301: YES), the CPU 310 determines a terminal to which the content information is to be transmitted. In this case, the CPU 310 looks up the transmission history of content information before updating and determines the terminal to which content information is to be transmitted. Further, the CPU 310 transmits a startup request to the display device 1 to which content information is to be transmitted (step S302).

On the other hand, when the CPU 310 determines that the content information to be updated does not exist (step S301: NO), the CPU 310 returns processing to step S301 again. In this manner, the existence or non-existence of the content information to be updated is monitored each time.

In the display device 1, when the CPU 10 receives the startup request from the server 300 (step S252) and determines that the CPU 10 receives the startup request (step S251: YES), the CPU 10 executes the terminal startup processing (step S253), and transmits startup completion information to the server 300 (step S254). The CPU 10 receives such a startup request also in a power-source ON time and executes the following processing.

In the server 300, when the CPU 310 receives startup completion information from the display device 1 (step S303), the CPU 310 transmits content information to be updated (containing additional information) to the CPU 10 (step S304). In this case, for example, additional information may be updated although content information per se is not updated. It is needless to say that content information per se may be also updated together with additional information. When the CPU 310 finishes this processing, the CPU 310 waits for a reception of a signal of “completion of reception” described later (step S305), and the CPU 310 returns processing to step S301 again.

In the display device 1, the CPU 10 receives content information to be updated from the server 300 (step S255), and transmits reception completion information to the server 300 (step S256).

Then, the CPU 10 allows the electrophoretic display device 21 to display updated power-source OFF time display information (step S257). In this processing, the CPU 10 looks up the additional information table for power-source OFF time shown in FIG. 6B and updates the received updated information. Then, the CPU 10 changes over the display of content information and additional information before updating with the updated content information and additional information.

Then, the CPU 10 allows the electrophoretic display device 21 to display a message “Power source is turned off” on a footer (a lower side of the display region) (step S258). Then, the CPU 10 executes the terminal stop processing (step S259), and returns processing to step S201 again.

Due to such processing, in a power-source OFF state, the CPU 10 temporarily brings the display device 1 into a power-source ON state from a power-source OFF state in response to a request from the server 300 (external device). Then, the CPU 10 updates (changes over) additional information to be displayed on the electrophoretic display device 21. Then, the CPU 10 brings the display device 1 into a power-source OFF state from a power-source ON state. Such processing is repeatedly executed at predetermined timings that display times associated with the respective additional information elapse.

Accordingly, even in a power-source OFF state, it is possible to change over additional information in response to a request from the external device so that it is possible to impart variations in additional information to be displayed. Still further, it is possible to temporarily bring the display device 1 into a power-source ON state so that a time during which the display device 1 is in a power-source ON state can be shortened thus realizing the further power saving.

Here, in the above-mentioned embodiment, although content information is stored in the memory card 23, the present invention is not limited to such a case, and content information may be stored in the EEPROM 18 of the display device 1 via a USB or the like, for example.

What is claimed is:

1. A display device comprising:
a non-volatile display part which is configured to maintain a display even when the supply of electricity from a power source is cut off;
a control part which is configured to drive the non-volatile display part thus allowing the non-volatile display part to display information thereon; and
an information storage part which is configured to store content information which contains information to be displayed on the non-volatile display part and additional information to be added to the content information, wherein
the control part is configured to display the additional information on the non-volatile display part when the display device is shifted from a power-source ON state to a power-source OFF state.

2. The display device according to claim 1, wherein the control part is configured to display, when the display device is shifted from the power-source ON state to the power-source OFF state, additional information which is added to the content information which is displayed in the power-source ON state immediately before the shifting of the display device to the power-source OFF state on the non-volatile display part.

3. The display device according to claim 1, wherein the control part is configured to repeatedly and temporarily shift the display device from the power-source OFF state to the power-source ON state at predetermined timing in the power-source OFF state and is configured to change over additional information to be displayed on the non-volatile display part.

4. The display device according to claim 1, wherein the control part is communicable with an external device, and
the control part is configured to temporarily shift the display device from the power-source OFF state to the power-source ON state in response to a request from the external device in the power-source OFF state, and is configured to change over additional information to be displayed on the non-volatile display part.

5. The display device according to claim 1, wherein the display device includes a manipulation part which is manipulable by a user, and
the control part is configured to shift the display device from the power-source ON state to the power-source OFF state when the manipulation of the manipulation part is not performed for a predetermined time.

6. A computer readable storage medium recording a program to be executed by a computer in a display device, the program causing the computer to perform the steps of:
maintaining a display on a non-volatile display part even when the supply of electricity from a power source is cut off;
displaying information on the non-volatile display part;
storing content information which contains information to be displayed on the non-volatile display part and additional information to be added to the content information; and
displaying the additional information on the non-volatile display part when the display device is shifted from a power-source ON state to a power-source OFF state.
